(19) United States
(12) Patent Application Publication
(10) Pub. No.: US 2010/0234771 A1
(43) Pub. Date: Sep. 16, 2010

(54) MASSAGE BENCH

(76) Inventor: Patrick Ingrassia, Amherst, NY (US)

Correspondence Address: Vincent G. LoTempio, Suite 1002, 69 Delaware Avenue, Buffalo, NY, 14202, US

(21) Appl. No.: 12/722,382

(22) Filed: Mar. 11, 2010

Related U.S. Application Data
(60) Provisional application No. 61/159,165, filed on Mar. 11, 2009.

(51) Int. Cl. A61H 1/00; A61G 13/06

(52) U.S. Cl. 601/1; 5/611

(57) ABSTRACT

A method and apparatus for providing a massage for a patient which comprises providing a massage bench made of a frame having two generally H-shaped leg assemblies connected to a floating horizontal cross member that controls the height of a platform. Positioning a patient below the massage bench and adjusting the height of the platform of the massage bench so that it is maintained at a specific height relative to the patient. Positioning a massage therapist on the massage bench so that the massage therapist is straddled over the patient while maintaining position and distribution of weight of the massage therapist over the patient. Distributing the massage therapist's weight from the massage bench to the patient while using the feet of the massage therapist to massage along the length of the body of the patient.

This application claims priority of U.S. Provisional Patent Application of Patrick Ingrassia, Ser. No. 61/159165 for MASSAGE BENCH, filed on Mar. 11, 2009.

### BACKGROUND OF THE INVENTION

1. Field of the Invention

This patent application relates to a massage bench to aid a therapist in performing massage therapy with patients. More specifically this patent application relates to a bench which can be used to both support the therapist during portions of the therapy session, as well as a prop used to position a patient for particular therapies. Further, this patent application relates to a method for massage using the massage bench of the present disclosure.

2. Background

Massage therapists often have shortened careers due to injury. The average career length for a massage therapist is 7 years. Injuries are generally due to repetitive strain to wrists, thumbs, and the lower back. When a therapist has an injury that disables the effective use of one hand, this injury significantly impacts patient care and therapist income because the therapist has no other way to perform massage techniques which require use of both hands. Furthermore, most therapists work per diem or independently. This work status limits the practicing massage therapists' access to affordable health care. In order to prevent loss of income, therapists may choose to work instead of completely healing an injury. Working injured can result in chronic conditions such as joint or connective tissue damage and scar tissue. The resulting pain and emotional distress, combined with the expenses of treating an injury, cause many massage therapists to end their careers or suffer severe losses in income due to an inability to perform adequately.

Therapists have developed various techniques to prolong their careers, including mounting two horizontal bars to a ceiling which allows the therapists to use their feet to massage; sitting on a chair or stool beside the patient when conducting massages using the feet; and by standing on the patient while the patient lies prone on the floor.

Mounting bars to a ceiling suffers numerous drawbacks including potential injury to both patient and therapist due to the therapist climbing up and down on the massage table in combination with the use of massage oils or lotions. Climbing up and down creates the risk of the therapist losing balance and falling onto the patient or off the table onto the floor. Further, it is questionable whether liability insurance covers this type of massage, or if the additional cost of said liability insurance is a practical expense for massage therapists.

Additionally, licensed massage therapists (LMT's) of average fitness and body weight may not be able to perform massage using ceiling mounted bars adequately. This type of massage requires levels of fitness, agility, and balance beyond the reach of many practicing LMT's. Although looking to address the longevity of massage therapist's careers, this modality is not a practical option for anyone who is in less than optimal fitness or at an age where achieving a high level of fitness and/or muscle strength and endurance is impractical if even possible.

Another drawback to holding onto bars mounted to the ceiling is the issue of unnecessary wear and tear on the therapist's body which is counterproductive to extending a career. When placing bars on the ceiling, the arms are held in an overhead position and support body weight for extended periods of time. The overhead position causes shoulder and neck impingement injuries. Furthermore, the therapist has to balance on one leg, thereby putting an excessive amount of pressure on the leg and hip joints while causing imbalance in the lower back.

Standing on one foot also limits the methods and techniques available to therapists because therapists are limited in using one foot to massage their patient—range of motion or joint manipulation is not possible only using one foot.

Finally, there is a total lack of portability when mounting bars to the ceiling, thus limiting the amount of income the therapist can generate with this modality. Since the bars are mounted just a few inches below the ceiling, there is a buildup of heat that the therapist is exposed to—causing discomfort and possible issues of overheating. This structure also limits the venues where the therapist may practice massage, as in order to set up this equipment certain ceiling heights and structural requirements are necessary. For instance, the therapist cannot mount bars to a drop-tile ceiling. Additionally, there is no oversight of the ceiling attachment systems to ensure safety, nor are therapists required to be trained in mechanical safety standards for installing this type of weight bearing equipment.

Therapists also attempt to employ stools or chairs to assist in massage therapies. However, there are numerous drawbacks to using a chair or stool. Therapists employing a stool or chair so that they may use their feet to massage patients are inadequately supported in several ways. Instability of chairs or stools may result if the chair or stool has wheels, or rotating seats. Additionally, most of these devices do not have handholds and have a small base of stability. Therefore, there is a risk of injury to the therapist from slippage and/or falling off a chair or stool. Furthermore, the therapist is unable to position himself or herself high enough to provide an effective table massage as most chairs or stools are not adjustable or do not telescope to table height. Finally, stable handholds are rarely available to create the leverage necessary to apply effective pressure to the patient, thus resulting in an ineffective massage treatment.

Standing on patients as they lie on the floor limits the methods and techniques available to therapists who are using only one foot to massage the patient. No range of motion or joint manipulation is possible when using only one foot. In order to apply any gliding motions or effleurage technique, a great deal of agility and balance is needed, which is out of the reach of many massage therapists who are insufficient physical fitness. Also, a therapist's career can be shortened because the therapist has to balance on one leg thereby putting an excessive amount of pressure on the leg and hip joints while also causing imbalance in the lower back. Additionally, some modalities employ the use of a staff for the therapist to lean on for stability. However, use of a single leg support may not be sufficient to create adequate stability for the therapist to maintain balance for long periods of time or over multiple massage sessions/patients.

Thus, it is readily apparent that there is a need for a device which safely extends a massage therapist's career. There is a particular need for a device which is stable, portable, and supportive for both the therapist and the patient.

### SUMMARY OF THE INVENTION

It is accordingly an object of the present disclosure to provide a massage bench with a wide, stable platform having a unique self-leveling feature that supports massage therapists by being fully balanced in any position.

A further object of the present disclosure it to provide a massage bench with a platform that adjusts easily to high and low levels, allowing for effective use in either table or floor treatments.

Still another object of the present disclosure is to provide a massage bench having non-skid devices to keep a firm grip on any floor surface and wide handholds to allow therapists to keep themselves in comfortable and ergonomically supportive positions.

Yet another object of the present disclosure is to provide a massage bench that allows therapists in a floor treatment to use a straddle position over their patients allowing therapists to use gravity and body weight effectively and safely on their patients.

Yet a further object of the present disclosure provides a massage bench that is portable because of its ability to be taken apart and put back together quickly as well as the bench being lighter and smaller than a portable massage table or massage chair, with fewer moving parts to maintain and no major requirements for room structure or additional equipment.

A further object of the present disclosure is to provide a method for massage designed to utilize the bench of the present disclosure.

The above and other objects are accomplished in accordance with the present disclosure which comprises a massage bench comprising: two end frames, each comprising two parallel vertical rods connected by at least one perpendicular horizontal cross member; at least one horizontal rod having means to removably affix the horizontal rod to the assembled end frames; and a bench having means for removable attachment to the assembled end frames.

### BRIEF DESCRIPTION OF THE DRAWINGS

The present disclosure and the manner in which it may be practiced is further illustrated with reference to the accompanying drawings wherein:

FIG. 1a is a perspective view of one embodiment of the present disclosure.

FIG. 1b is an illustration of a method of performing a massage according to one embodiment of the present disclosure.

FIG. 2 is an exploded view of the major components comprising one embodiment of the present disclosure.

FIG. 3 is a perspective view of a partial construction of one embodiment of the present disclosure.

FIG. 4 is a perspective view of the positioning of the bench in one embodiment of the present disclosure.

### DESCRIPTION OF SPECIFIC EMBODIMENTS

At the outset, it should be clearly understood that reference numerals are intended to identify the information found in the block diagrams in the several drawing figures, as may be further described or explained by the entire written specification of which this detailed description is an integral part. The drawings are intended to be read together with the specification and are to be construed as a portion of the entire “written description” of this disclosure as required by 35 U.S.C. §112.

The present disclosure provides for a massage bench having a wide, stable platform that can be height adjusted allowing the bench to be used in either floor or table massage treatments. The massage bench has a rigid yet flexible frame which allows the bench to self-level when placed on an uneven surface. Self-leveling of the bench ensures that a massage therapist maintains balance and is fully supported while performing a massage treatment. The massage bench also features anti-skid feet to firmly grip any floor surface and wide handholds to allow the therapist to ergonomically support himself or herself while performing various exercises during the course of a treatment. Further, massage therapists frequently travel to remote locations to perform therapy, thus creating the necessity for a portable piece of equipment that is light and compact while also being easily assembled and disassembled.

The massage bench of the present disclosure is designed to be a multi-functional massage tool permitting methods of massage not currently available. In one treatment method, the massage bench is placed over a patient during a floor treatment allowing the therapist to straddle the patient and utilize gravity and the therapist's body weight to effectively and safely perform massage. In a second treatment method, the bench lies alongside a patient during a table message. The massage therapist adjusts the level of the bench platform so as to be elevated slightly higher than the prone patient. The therapist can then use his or her feet and/or hands to conduct range of motion or joint manipulation exercises. Lastly, the height of the bench can be adjusted to match the height of the massage table, permitting the therapist to use the bench as an extension of the table for range of motion exercises.

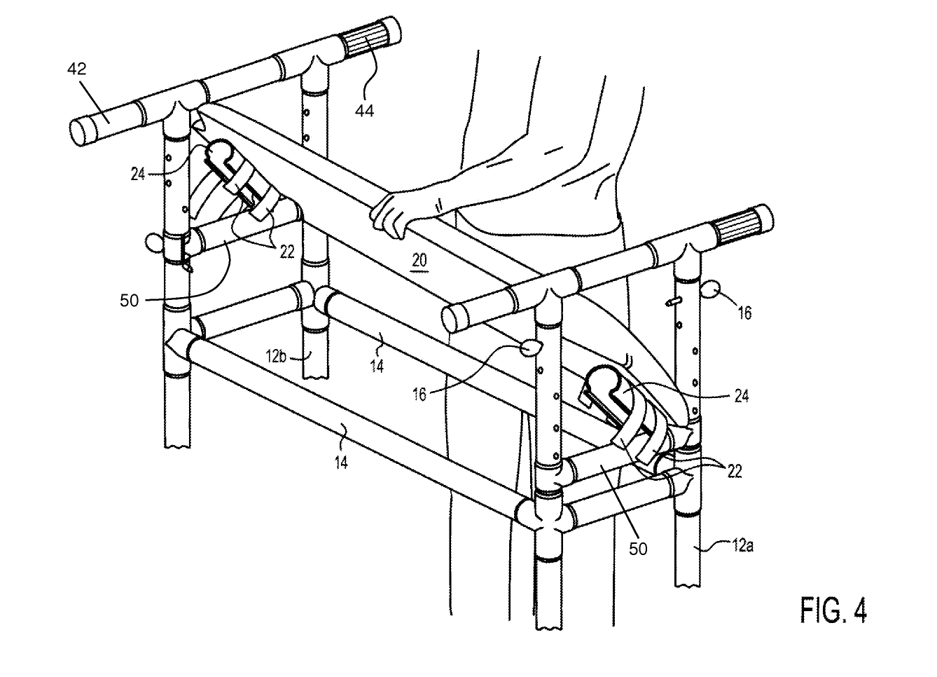

Adverting now to the drawings, with reference to FIG. la, a preferred embodiment of the present disclosure is indicated by numeral 10 which generally is comprised of two leg assemblies 12a and 12b, which are connected by horizontal cross members 14 and support platform 20. Height adjustment pins 16 are used in conjunction with holes 52 in vertical legs 30 so as to removably position support platform 20 on floating horizontal cross member 50 (as shown in FIG. 4) to a height desired by the user/massage therapist.

In a preferred embodiment, leg assemblies 12a and 12b comprise two parallel vertical legs 30 rigidly affixed to one another by a stationary horizontal cross member 32 to roughly form an H-shaped frame. In another embodiment, additional stationary horizontal cross members 34 are employed to increase rigidity and decrease flexibility of the assembled frame. Parallel vertical legs 30 can further house pneumatically adjusted elevators which independently control the length of each vertical member. This pneumatic adjustability allows the practitioner to quickly and easily control the level of the bench.

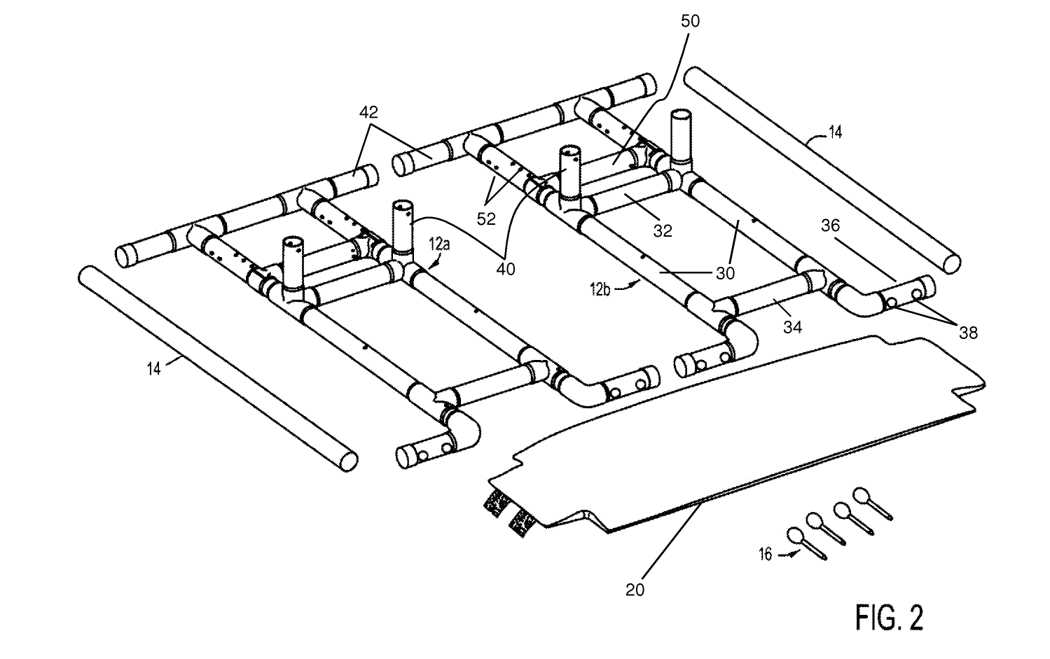

As shown in FIG. 2, an exploded view of the preferred embodiment of the present disclosure, leg assemblies 12a and 12b can have an L-shaped bottom to form horizontal foot members 36 to further increase stability. The assemblies and associated parts can be easily assembled and disassembled. This is important because massage therapists frequently travel to remote locations to perform therapy and the table necessarily needs to be disassembled and reassembled.

The foot members 36 are flexible extensions of the leg which maintains the stability of the massage bench while the therapist is performing a massage. Flexible leg extensions 36 may have anti-slip material 38 placed on the portion which will contact the floor to prevent movement of the bench during use. In an alternative embodiment, anti-slip material 38 can be affixed to an adjustable threaded foot which is housed in a threaded portion of foot member 36. The threaded foot with anti-slip material can be height adjusted by turning the foot clockwise or counter-clockwise in a threaded portion of foot member 36. The threaded foot may further comprise a spring-loaded rolling castor wheel. The wheels make the bench easier to relocate and maneuver during a massage session. During use, the therapist's weight compresses the spring causing the wheel to become covered by the body of the castor creating a stable, non-rolling foot for the bench.

Leg assemblies 12a and 12b may further comprise handle 42. Handles 42 are positioned at the top of the vertical members 30 and can, as shown, extend perpendicularly between and beyond vertical members 30, or vertical legs 30 can be L-shaped having the handles 42 extend perpendicularly outward from vertical legs 30 similar to foot members 36 (not shown). Alternatively, the outwardly extending portion of handle 42 can be composed of adjustable, telescopic handholds that can be positioned at any desired height and angle. Additionally, as shown in FIG. 4, handle 42 can further comprise an anti-slip grip portion 44. Grip portion 44 can be constructed of any anti-slip material such as figured rubber, any suitable plastic or the like. Grip portions 44 aid the massage therapist during repositioning of the bench or when the bench is used as a prop to allow the therapist to increase force during treatment. Ensured grip is of particular importance when massage oils are used or if the therapist has perspiration on his or her hands.

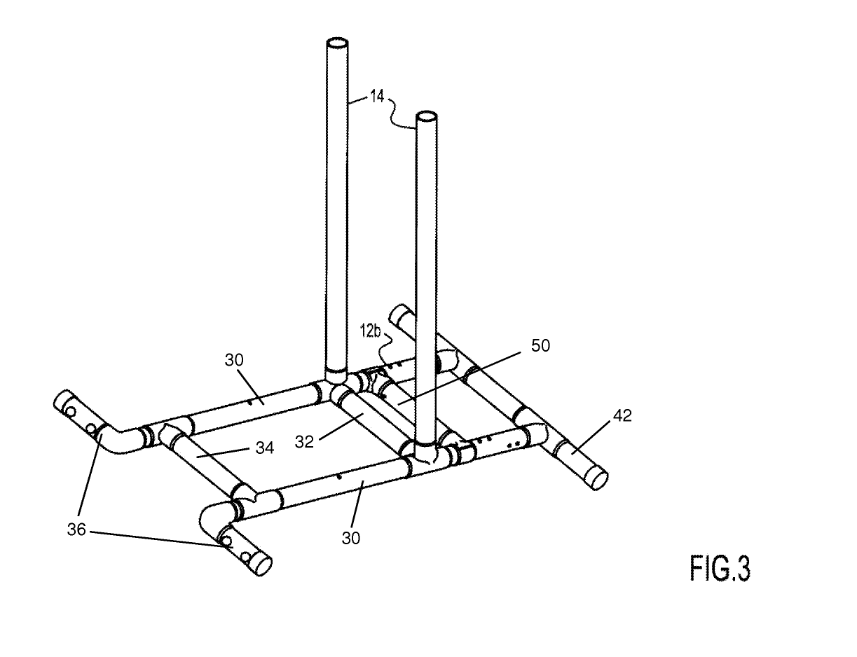

In a preferred embodiment, leg assemblies 12a and 12b further comprise short perpendicular members 40 which are configured to removably connect horizontal members 14 to the leg assemblies (as demonstrated in FIG. 3). Perpendicular members 40 are configured to have an outer diameter just slightly smaller than the inner diameter of horizontal members 14 such that, when assembled, horizontal members 14 fit snuggly around perpendicular members 40. Horizontal members 14 can be made of rigid yet flexible materials such that the massage bench will remain sturdy and maintain stability while also allowing massage bench 10 to flexibly self-adjust when placed on uneven flooring.

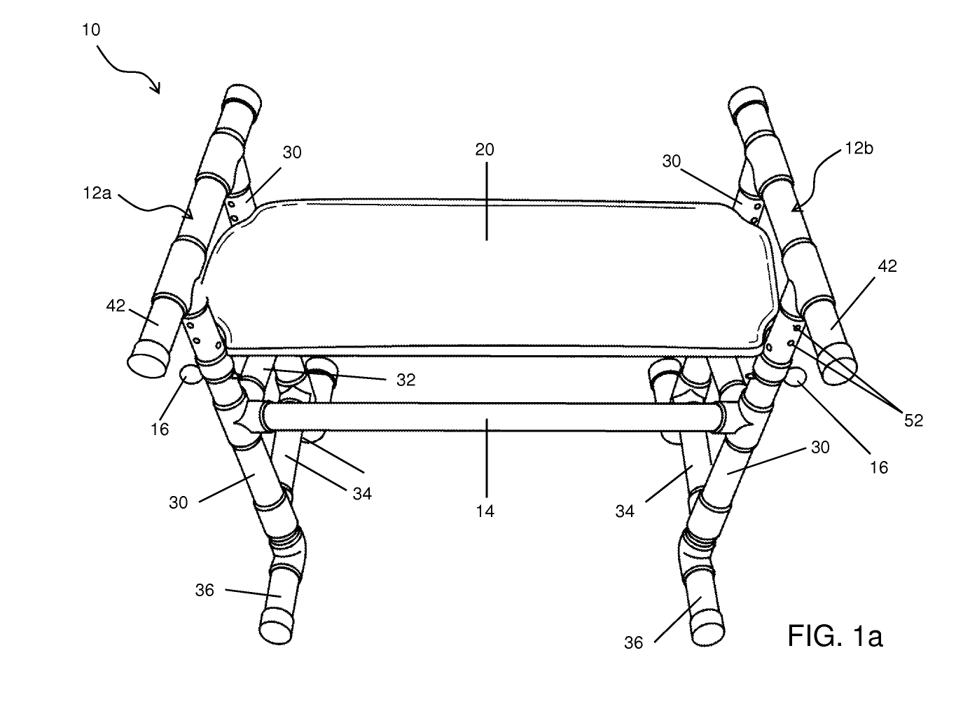

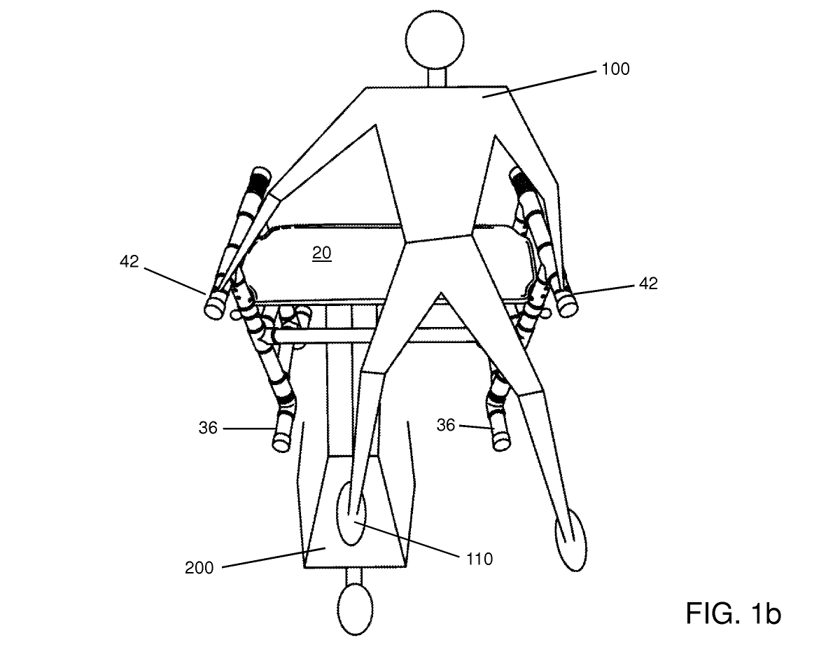

Preferably, as shown in FIGS. 1a through 4, each leg assembly 12a and 12b comprises a dedicated, floating horizontal cross member 50. The height of the floating horizontal cross member can be adjusted and firmly positioned using adjustment pins 16 placed in holes 52 drilled within each vertical leg of the leg assemblies. Platform 20 is removably attached to floating horizontal cross member 50 of each leg assembly 12a and 12b, as shown in FIG. 4, depending on the desired height of platform 20.

FIG. 4 further shows one envisioned method for removably affixing platform 20 to the floating horizontal cross members. In this particular embodiment, platform 20 has retaining clips 24 rigidly affixed at each end of the platform. Platform 20 further has hook and loop fasteners 22 rigidly affixed to the platform such that, when attached, the closed circle of the hook and loop fastener incorporates retaining clip 24. Hook and loop fasteners 22 are of sufficient length to overlap with one another when platform 20 and retaining clip 24 are placed over floating horizontal cross member 50, as shown in FIG. 4. Although in the preferred embodiment the platform is positioned on floating horizontal cross members 50 so that the platform height is easily adjusted during use by removing and repositioning the adjustment pins in conjunction with holes 52, the retaining clip of the platform is configured so as to be easily placed over and connected to any horizontal cross member for desired height positioning. Floating horizontal cross members 50 move independently and can be positioned so that the platform is parallel to the floor or adjusted at different heights so that one end of the platform may be higher than the other (as shown in FIG. 4).

Utilizing a massage bench of a preferred embodiment of the present disclosure allows a massage practitioner to develop a new massage method. Described below are examples of exercises using the method in conjunction with a massage bench of the present disclosure.

One embodiment of a method of massage utilizing the massage bench of the present disclosure is shown in FIB. lb wherein the massage bench is positioned over a massage patient 200 with the massage therapist or practitioner 100 straddling above the patient. The practitioner then uses one or both of his or her feet 110 to apply pressure to the patient's body. The massage therapist can slide left/right on the bench platform 20 to access different locations along the patient's body. Importantly, the position of the massage practitioner above the patient creates easy use of leverage and body weight to apply pressure. In this embodiment of the method, the magnitude and direction of the force applied to the patient is safely and easily controlled by the practitioner. Moreover, the stability of the massage bench is of paramount importance and each foot 36 of the bench needs to be firmly balanced and secure on the floor. The practitioner can be seated on the bench platform 20 and use the hand grips 42 for added stability. While using the massage bench, the patient is covered with oil or lotion with no impact on the practitioner's comfort or ability to conduct a massage treatment. When performing massage with the feet using ceiling mounted bars or when using a stool or chair, a patient covered with oil or lotion places the practitioner's stability and control of weight and balance in constant jeopardy. In each of these alternatives, the practitioner has a much greater chance of injuring himself or herself or the patient as these alternatives do not provide the stability and maneuverability that is afforded the practitioner by use of the massage bench of the present disclosure. Additionally, the amount of force used in the massage is much more difficult to control or maintain while the direction of the force applied is restricted, namely to a downward force when using ceiling mounted bars.

Another embodiment of a method of the present disclosure in conjunction with the massage bench of the present disclosure, has the massage practitioner adjust the level of the bench such that the bench is higher than the level of the patient as the patient lies on a massage table. The practitioner then utilizes his or her hands and feet simultaneously to conduct a table massage. This embodiment of a method creates greater efficiency as both the practitioner's hands and/or feet are used while minimizing strain on the massage practitioner's body as the practitioner is able to comfortably sit on the bench. The practitioner no longer has to continually stand and reseat himself or herself during the course of a massage session as would be the case in conducting a similar massage but having the patient lie on the floor during the session. Furthermore, the height adjustability of one embodiment of the present disclosure allows the bench to be positioned at a height where the therapist can apply downward gravitational pressure. Downward gravitational pressure is not possible when attempting this method with the patient lying on the floor.

An additional embodiment of a massage method using the massage bench of the present disclosure has the massage bench used for table massage techniques. The massage practitioner, using a preferred embodiment of a method of the present disclosure, is able to adjust the bench level so that is of an equal height with the patient's body while the patient lies on a adjacent massage table. The practitioner can the sit on the bench and use his or her hands and feet to conduct various massage exercises. The use of the practitioner bench and patient massage table creates a method for efficient application of lateral pressure, ease of use, and the ability to apply range of motion techniques. Further, the adjustability of the bench as in one embodiment of the current disclosure allows the massage practitioner to use techniques in a table massage that normally could only be used in a floor massage, but with the benefit of having the massage therapist supported ergonomically without having to get up and down off the floor. Moreover, having the massage bench at an equal height with the massage table allows the massage bench to be utilized as a massage table extension for the upper body or for the lower body. The height of the massage bench can be adjusted to allow the patient to rest his or her arm or leg on the massage bench while lying on the massage table. The massage practitioner is able to fully access the patient for a combination of joint manipulation, range of motion stretching, and pressure based techniques not possible without the use of the bench where the patient's arm or leg extends beyond the massage table is unable to rest on another platform.

What I claimed is:

1. An adjustable bench for performing a massage comprising:
(a) a frame comprised of a first generally H-shaped leg assembly connected to a second generally H-shaped leg assembly wherein each leg assembly is comprised of two vertical legs and at least one stationary horizontal cross member rigidly affixed between said vertical legs;
(b) a floating horizontal cross member movably affixed above each of said stationary horizontal cross members;
(c) a platform removably affixed to each of said floating horizontal cross members so that the floating cross members support the platform for movement with respect to the vertical legs; and
(d) a means for adjustably locking the height of said platform.

2. The adjustable bench for performing a massage of claim 1 wherein generally L-shaped handles are affixed to said vertical legs.

3. The adjustable bench for performing a massage of claim 2 wherein said generally L-shaped handles are telescopically adjustable.

4. The adjustable bench for performing a massage of claim 2 wherein said L-shaped handles have an anti-slip grip around said handle.

5. The adjustable bench for performing a massage of claim 4 wherein said anti-slip grip is comprised of rubber.

6. The adjustable bench for performing a massage of claim 1 wherein generally L-shaped feet having a top and bottom surface are fixed affixed to said vertical legs.

7. The adjustable bench for performing a massage of claim 6 wherein said generally L-shaped feet have an anti-slip material along the bottom surface of said feet.

8. The adjustable bench for performing a massage of claim 1 wherein said floating cross members are releasably locked in place by a control pin.

9. The adjustable bench for performing a massage of claim 1 wherein said floating cross members are configured to move independently so that said platform can be positioned at an acute angle relative to one of said vertical legs.

10. The adjustable bench for performing a massage of claim 1 wherein said floating cross members are configured to position said platform perpendicular to said vertical legs.

11. The adjustable bench for performing a massage of claim 1 wherein said means for adjustably locking the height of said platform is done by pneumatic control.

12. A method for providing a therapeutic massage for a patient, which method comprises:
a) providing a massage bench comprising:
i) a frame having a first generally H-shaped leg assembly connected to a second generally H-shaped leg assembly wherein each leg assembly is comprised of two vertical legs and at least one stationary horizontal cross member rigidly affixed between said vertical legs;
ii) a floating horizontal cross member movably affixed above each of said stationary horizontal cross members;
iii) a platform removably affixed to each of said floating horizontal cross members so that the floating cross members support the platform for movement with respect to the vertical legs;
iv) adjustable handles affixed to said vertical legs; and
v) a means for releasably adjusting the height of said platform;
b) positioning the patient below the massage bench;
c) adjusting the height of said platform of the massage bench so that it is in a specific height relative to the patient;
d) positioning the a massage therapist on the massage bench so that the massage therapist is straddled over the patient; and
e) distributing the weight of the massage therapist from the massage bench to the patient while using the feet of the massage therapist to massage along the length of the body of the patient.

13. The method for providing a therapeutic massage for a patient of claim 12 further comprising maintaining position and distribution of weight of the massage therapist over the patient by holding onto the adjustable handles of the massage bench.

14. A method for providing a therapeutic massage for a patient, which method comprises:
a) providing a massage bench comprising:
i) a frame having a first generally H-shaped leg assembly connected to a second generally H-shaped leg assembly wherein each leg assembly is comprised of two vertical legs and at least one stationary horizontal cross member rigidly affixed between said vertical legs;
ii) a floating horizontal cross member movably affixed above each of said stationary horizontal cross members;
iii) a platform removably affixed to each of said floating horizontal cross members so that the floating cross members support the platform for movement with respect to the vertical legs;
iv) adjustable handles affixed to said vertical legs; and
v) a means for releasably adjusting the height of said platform;
b) positioning the patient below the massage bench;
c) adjusting the height of said platform of the massage bench so that it is in a specific height relative to the patient;
d) positioning the a massage therapist on the massage bench so that the massage therapist is straddled over the patient;
e) maintaining position and distribution of weight of the massage therapist over the patient by holding onto the adjustable handles of the massage bench; and
f) distributing the weight of the massage therapist from the massage bench to the patient while using the feet of the massage therapist to massage along the length of the body of the patient.
